(19) United States
(12) Patent Application Publication
(10) Pub. No.: US 2007/0286030 A1
(43) Pub. Date: Dec. 13, 2007

(54) TIMING SYSTEM AND METHOD

(76) Inventor: DALE E. BRECH, Tucson, AZ (US)

Correspondence Address: NOBLITT & GILMORE, LLC., 4800 NORTH SCOTTSDALE ROAD, SUITE 6000, SCOTTSDALE, AZ, 85251, US

(21) Appl. No.: 11/691,625

(22) Filed: Mar. 27, 2007

Related U.S. Application Data
(60) Provisional application No. 60/743,792, filed on Mar. 27, 2006.

(51) Int. Cl. G04F 1/00

(52) U.S. Cl. 368/89

(57) ABSTRACT

The disclosed system, device and method for representing time generally includes an input module, a run module, and a display module. The input module may be suitably configured to produce a user request data set in response to a user input. The run module may be suitably configured to generate a time series in response to the user request data set. The display module may be suitably configured to produce an on-screen timer in accordance with the user request data set and the time series.

### CROSS-REFERENCES TO RELATED APPLICATIONS

This application claims the benefit of U.S. Provisional Patent Application No. 60/743,792 filed in the United States Patent and Trademark Office on Mar. 27, 2006 by Dale Brech.

### FIELD OF INVENTION

The present invention generally concerns time management systems, devices and methods; and more particularly, representative and exemplary embodiments of the present invention generally relate to computer time management applications and applets.

### BACKGROUND OF INVENTION

Communication is a critical aspect of human activity. Given that human beings are limited to perform task over a given duration and generally operate in accordance with discrete time intervals, the time in which people are available to communicate may be scarce. More efficient mechanisms of communication are therefore desirable.

Within an organization, communication must generally be engaged in order to transfer information between people in a given amount of time. Maintaining focus within a meeting or presentation setting may be challenging, yet important, because of the time invested by the participants. All participants will ordinarily focus on the conversation in view of the time constraints. Rendering the temporal aspect of such meetings an explicit component of the activity itself enables the participants to gauge the amount of time that may be allotted for questions or tangential conversations.

Current systems for representation of time constraints may involve a wristwatch, a wall clock, flashing lights, buzzers, and rude comments. While these methods provide a visible and/or audible method of tracking the passage of time, they may be distracting, impolite or otherwise prove cumbersome in the context of a particular meeting.

### SUMMARY OF THE INVENTION

In various representative aspects, the present invention provides systems and methods for representing the passage of time. Exemplary features generally include:
an input module, a run module, and a display module. The input module may be suitably configured to produce a user request data set in response to a user input. The run module may be suitably configured to generate a time series in response to the user request data set. The display module may be suitably configured to produce an on-screen timer in accordance with the user request data set and the time series.

Advantages of the present invention will be set forth in the Detailed Description which follows and may be apparent from the Detailed Description or may be learned by practice of exemplary embodiments of the invention. Still other advantages of the invention may be realized by means of any of the instrumentalities, methods or combinations particularly pointed out in the claims.

### BRIEF DESCRIPTION OF THE DRAWINGS

Representative elements, operational features, applications and/or advantages of the present invention reside inier alia in the details of construction and operation as more fully hereafter depicted, described and claimed—reference being made to the accompanying drawings forming a part hereof, wherein like numerals refer to like parts throughout. Other elements, operational features, applications and/or advantages will become apparent in light of certain exemplary embodiments recited in the detailed description, wherein:

FIG. 1 representatively illustrates a block diagram of an on-screen timer system in accordance with an exemplary embodiment of the present invention;

FIG. 2 representatively illustrates a user input window in accordance with an exemplary embodiment of the present invention;

FIG. 3 representatively illustrates a screenshot featuring an on-screen timer bar in accordance with an exemplary embodiment of the present invention;

FIG. 4 representatively illustrates a screenshot featuring an on-screen timer integrated with a presentation program in accordance with an exemplary embodiment of the present invention; and

FIG. 5 representatively illustrates a flowchart of a method of displaying an on-screen timer in accordance with an exemplary embodiment of the present invention.

Elements in the Figures are illustrated for simplicity and clarity and have not necessarily been drawn to scale. For example, the dimensions of some of the elements in the Figures may be exaggerated relative to other elements to help improve understanding of various embodiments of the present invention. Furthermore, the terms “first”, “second”, and the like herein, if any, are used inter alia for distinguishing between similar elements and not necessarily for describing a sequential or chronological order. Moreover, the terms “front”, “back”, “top”, “bottom”, “over”, “under”, “forward”, “aft”, and the like in the Description and/or in the claims, if any, are generally employed for descriptive purposes and not necessarily for comprehensively describing exclusive relative position. Any of the preceding terms so used may be interchanged under appropriate circumstances such that various embodiments of the invention described herein, for example, may be capable of operation in other configurations and/or orientations than those explicitly illustrated or otherwise described.

### DETAILED DESCRIPTION OF EXEMPLARY EMBODIMENTS

The following representative descriptions of the present invention generally relate to exemplary embodiments and the inventor's conception of the best mode, and are not intended to limit the scope, applicability or configuration of the invention in any way. Rather, the following description is intended to provide convenient illustrations for implementing various embodiments of the invention. As will become apparent, changes may be made in the function and/or arrangement of any of the elements described in the disclosed exemplary embodiments without departing from the spirit and scope of the invention.

The present invention is described herein with reference to block diagrams and flowchart illustrations of methods, apparatus (e.g., systems), and computer program products according to various aspects of the invention. It will be understood that each functional block of the block diagrams and the flowchart illustrations, and combinations of functional blocks in the block diagrams and flowchart illustrations, respectively, may be implemented by computer program instructions. These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

Various representative implementations of the present invention may be applied to any system for displaying temporal information. Certain representative implementations may include, for example: an animated graphic bar, a rotating disk, and/or the like. The display of temporal information may be suitably configured to fluctuate as a function of time over a specified period of time. Such a system may be suitably configured as a stand-alone computer program, or may be alternatively, conjunctively or sequentially integrated within another computer program (e.g., slide show application, etc.) and/or the like. A detailed description of an exemplary application, namely an on-screen timer, is provided as a specific enabling disclosure that may be generalized to any application of the disclosed system, device and method for representing time in accordance with various embodiments of the present invention.

In various representative embodiments in accordance with the present invention, a system and method for a timer display may include various software and/or hardware modules configured to process a specified signal in a specified manner. For example, a software module may be suitably configured to retrieve information from an operating system relating to the position and/or click activity of a peripheral device. As another example, a software module may be suitably configured to process an incoming signal with reference to a graphics library and/or a graphics display program. As yet a further example, a software module may be suitably configured to display a graphic according to a specified temporal sequence.

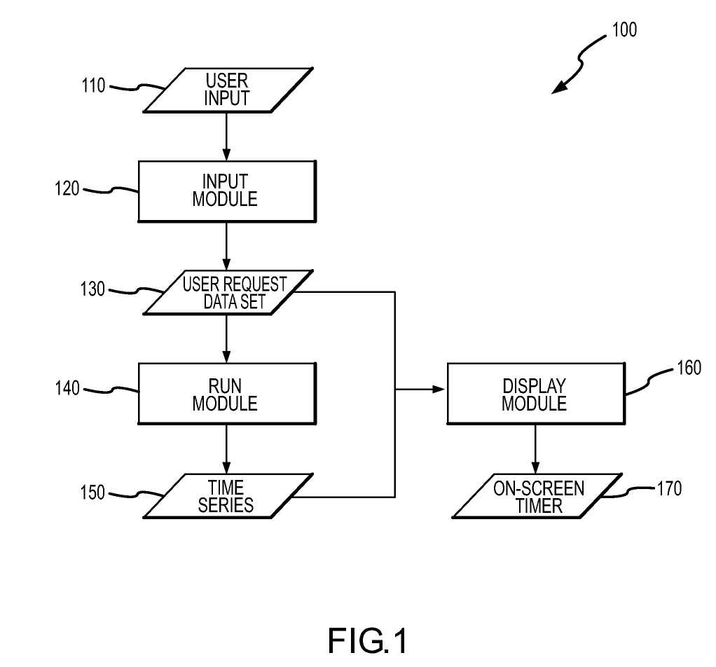

As generally depicted in FIG. 1, a representative embodiment of the present invention may be illustrated by a block diagram of system 100 for displaying on-screen timer 170 according to user input 110. System 100 may comprise input module 120, run module 140, and display module 160. Input module 120 may be suitably configured to generate user request data set 130 in response to user input 110. Run module 140 may be suitably configured to generate time series 150 in response to user request data set 130. Display module 160 may be suitably configured to generate on-screen timer 170 in response to at least one of user request data set 130 and time series 150.

System 100 may be suitably configured to process user input 110 and generate an on-screen timer 170. System 100 may be suitably adapted to any system for representing temporal information, such as within a specified hardware implementation, in conjunction with a specified software implementation, distributed across a specified network, and/or the like. In the present embodiment, system 100 comprises a plurality of software modules wherein system 100 may be suitably configured to receive user input 110 and process that user input 110 to generate on-screen timer 170.

During installation of system 100, user may be prompted regarding whether on-screen timer 170 is to be stand-alone or integrated within another program. In a stand-alone embodiment, on-screen timer 170 may be accessed directly, as through a corresponding desktop icon. In an integrated embodiment, on-screen timer 170 may be accessed via another program, such as through a submenu appearing during operation of such program.

User input 110 may comprise instructions transmitted to system 100 by a user. User input 100 may comprise information such as position coordinates relating to the position of a cursor within a graphical user interface (GUI) and/or information relating to actuation of a specified electromechanical switch, such as a mouse click, actuation of a key on a keyboard, interaction with a touchscreen, and/or the like. User input 110 may be quantified and/or processed prior to receipt within system 100, for example, via software associated with an operating system. For implementations in which system 100 comprises a GUI, user input 110 may be entered into fields within the GUI and/or selected from a menu of commands within the GUI.

Input module 120 is generally responsive to user input 110. For example, input module 120 may be that portion of system 100 configured to retrieve user input 110. Accordingly, input module 120 may comprise a port configured to communicate with an operating system and/or a port configured to receive a signal from peripheral devices such as a mouse, keyboard, touchscreen, and/or the like. In the event that user input 110 requires processing, such as reformatting, prior to use within system 100, input module 120 may be suitably configured to process user input 110 accordingly. Input module 120 may be adapted to correlate user input 110 with subroutines within system 100, such as by identifying within user input 110 a command relating to display of a specified animation, by identifying within user input 100 a command relating to duration of on-screen timer 170, and/or the like. Input module 120 may generate a GUI in response to activation of system 100 and provide fields within which a user may enter information.

User request data set 130 comprises user input 110 as processed by input module 120. User request data set 130 may comprise information relating to the desired duration of on-screen timer 170, information relating to the display of a warning via on-screen timer 170, information relating to an audio warning in conjunction with on-screen timer 170, information relating to selection of a specified on-screen timer 170, and/or the like. User request data set 130 may comprise machine-readable code formatted for processing within at least one of run module 140 and display module 160.

Run module 140 is generally responsive to user request data set 130 and/or user input 110. Run module 140 may be suitably configured to determine an animated sequence relating to user input 110. Run module 140 may comprise a graphics library and/or an animation program. For example, in response to user request data set 130 indicating that user would like a 100 second timer in the form of a bar, run module 140 may be suitably configured to determine elements within the graphics library such that when displayed, such elements form an animated sequence showing a timing bar decreasing in length as a function of the specified time.

Time series 150 generally comprises information as processed by run module 140. In the event that run module 140 comprises a graphics library, time series 150 may comprise a plurality of animation instructions relating portions of the graphics library to the user request data set. For example, time series 150 may comprise the animation instructions as generated by run module 140.

Display module 160 is generally responsive to user request data set 130, user input 110, and/or time series 150. Display module 160 may be suitably configured to selectively display time series 150. For example, display module 160 may suitably display the animation in accordance with the animation instructions as generated by run module 140. Display module 160 may be suitably configured to operate with a specified graphics card, a specified computer monitor, and/or the like.

On-screen timer 170 may comprise information as processed by display module 160. The properties of on-screen timer 170 may relate to user input 110, user request data set 130, and/or time series 150. On-screen timer 170 may comprise a graphical display simulating at least one a timing bar, a digital clock, an analog clock, an hourglass, a solar cycle, a lunar cycle, a pastoral setting cycling through the seasons, and/or the like.

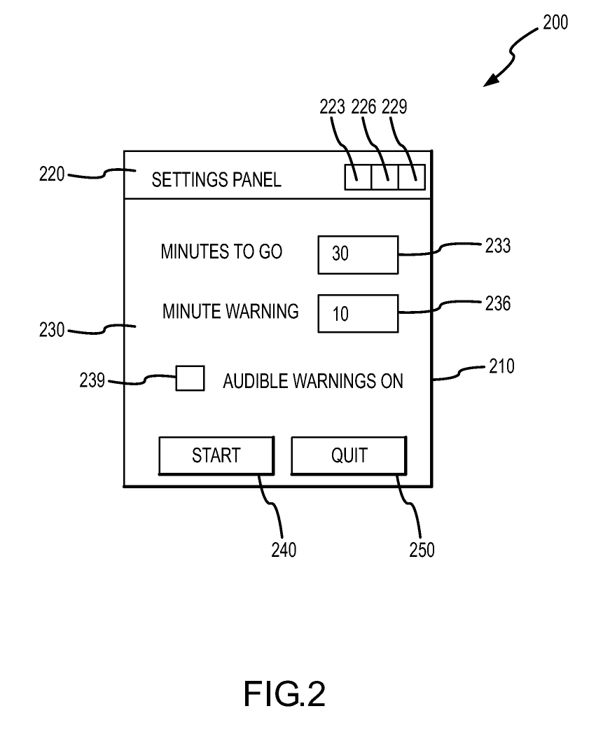

As generally depicted in FIG. 2, a representative embodiment of the present invention includes graphical user interface (GUI) 200 suitably configured to receive commands from a user and defined by window 210. GUI 200 may suitably comprise various fields, such as GUI settings bar 220, input field 230, start button 240, and/or quit button 250.

GUl 200 may comprise an interactive display configured to receive user input 110. GUI 200 may be generated in accordance with an operating system. For example, the operating system sold under the trademark MICROSOFT® WINDOWS® (Redmond, Wash., USA) may comprise a system for display programs within a uniform interface scheme. GUI 200 may operate in accordance with such system.

Window 210 may define the boundaries of GUI 200 on a display screen. For example, window 210 may have a length and width. The dimensions of window 210 may be modified through clicking and dragging of the edges and/or via GUI settings bar 220.

GUI settings bar 220 may comprise a field within window 210 displaying information relating to operation of system 100. GUI settings bar 220 may comprise text relating to the filename and/or path of system 100. GUI settings bar 220 may comprise subfields, such as minimize field 223. For example, minimize field 223 may be configured to disappear GUI 200 from its present format and represent GUI 200 with an exemplary icon. GUI settings bar 220 may also comprise a subfields such as restore/maximize field 226. As another example, restore/maximize field 226 may be suitably configured to alternatively contract window 210 to a smaller portion of the display screen and hold GUI 200 fast against the maximum boundaries of the display screen. GUI settings bar 220 may further comprise subfields such as close field 229. As yet another example, close field 229 may be configured to exit system 100 with a single click. GUI settings bar 220 may be suitably configured in accordance a uniform interface scheme within an operating system.

Input field 230 may comprise a portion of GUI 200 suitably configured to receive user input 110. Input field 230 may comprise duration subfield 233 suitably configured to receive user input 110 relating to the total duration of on-screen timer 170. Input field 230 may also comprise minute warning subfield 236 suitably configured to receive user input 110 relating to the time at which a user would like to display a warning. Input field 230 may further comprise audible warning subfield 239 suitably configured to provide an audio signal in response to a specified duration or durations.

The various subfields may be suitably configured in various embodiments with regard to entry of user input 110. For example, duration subfield 233, minute warning subfield 236, and/or audible warning subfield 239 may comprise a text entry window configured to receive user input 110 via a keyboard. In another exemplary embodiment, duration subfield 233, minute warning subfield 236, and/or audible warning subfield 239 may comprise a menu of possible durations and user input 110 may be entered by selecting from among the possible durations. In yet another exemplary embodiment, audible warning subfield 239 may be configured to receive user input 110 relating to the selection of one audible warning embodiment from among a plurality, for example, “ding”, “buzz”, a recorded message, and/or the like.

Input field 230 may comprise one or more fields relating to the properties of on-screen timer 170. Input field 230 may comprise a graphic options field suitably configured to receive user input 110 relating to selection of a graphics theme from a plurality of graphics themes. For example, system 100 may comprise various embodiments of on-screen timer 170 such as a timing bar, a digital clock, an analog clock, an hourglass, a solar cycle, a lunar cycle, and a pastoral setting cycling through the seasons, and/or the like. In addition, the various embodiments of on-screen timer 170 may be further modified, such as modification to color schemes, various designs within the embodiments, combinations of various embodiments, and/or the like.

Input field 230 may comprise one or more fields relating to activation of system 100 in response to a specified event. Input field 230 may comprise a synchronization field suitably configured to receive user input 110 relating to triggering of on-screen timer 170 in response to a specified event within the operating system. For example, the operating system may be configured to operate in conjunction with other programs, such as word processing, data processing, presentation, entertainment, and/or the like. Input field 230 may comprise a synchronization field configured to receive user input 110 and cause activation of on-screen timer 170 in response to activation of one or more of the other programs. For example, on-screen timer may be configured to display on-screen timer in response to activation of a specified computer game, a specified word processing program, a specified spreadsheet program, a specified system time, and/or the like.

Start button 240 may be configured to activate system 100. For example, user input 110 may indicate that the user would like to activate on-screen timer 170 immediately. Accordingly, start button 240 may be suitably configured to trigger activation of on-screen timer 170 upon actuation of start button 240. As another example, user input 110 may indicate that the user would like to activate on-screen timer 170 whenever a specified computer program is activated. Consequently, start button 240 may be suitably configured to trigger activation of on-screen timer 170 upon activation of the specified computer program.

Quit button 250 may be configured to abort activation of system 100. User input 110 entered prior to actuation of quit button 250 may be saved and retrieved upon the next activation of GUI 200. Alternatively, user input 100 entered prior to actuation of quit button 250 may be automatically deleted. Upon actuation of quit button 250, GUI 200 closes and system 100 is at least temporarily disabled.

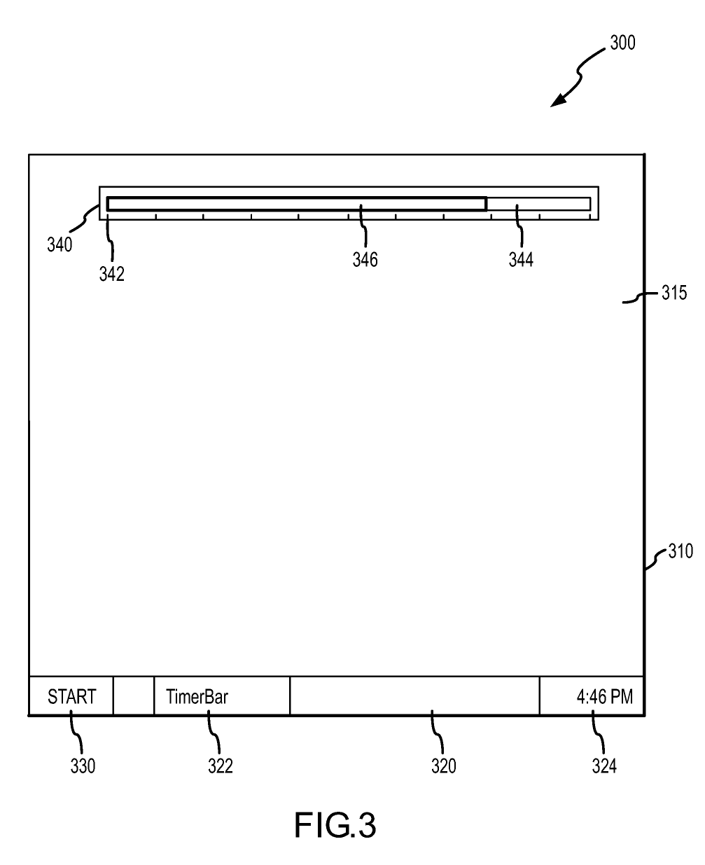

As generally depicted in FIG. 3, another representative embodiment of the present invention is illustrated with a screenshot of an exemplary embodiment 340 of on-screen timer 170 in operation. On-screen timer 340 may operate within GUI 300. Within GUI 300, on-screen timer 340 may be defined by window 310 and comprises information bar 320 and start button 330.

GUI 300 may comprise a display screen running a GUI operating system. For example, GUI 300 may comprise a desktop screen of the GUI operating system sold under the name MICROSOFT® WINDOWS® (Redmond, Wash., USA). The properties of GUI 300 may vary according to the parameters of GUI 300 and/or user preferences.

Window 310 may comprise the boundaries of GUI 300. For example, window 310 may have parameters corresponding to the hardware display module on which GUI 300 operates. Window 310 may comprise various fields. For example, window 310 may comprise: activity field 315 in which the user may manipulate programs; information bar 320 in which the user may be informed regarding system events; and start button 330 with which the user may access various programs.

Information bar 320 may be suitably configured to display icon 322 relating to programs currently operating within activity field 315. Information bar 320 may also include system information field 324 comprising information such as background programs in operation, system time, and/or the like. For example, information bar 320 may comprise the corresponding structure as displayed by the GUI operating system sold under the name MICROSOFT® WINDOWS® (Redmond, Wash., USA).

Actuation of start button 330 may trigger the display of a menu relating to selection of various system programs. For example, start button 330 may comprise the corresponding structure as displayed by the GUI operating system sold under the name MICROSOFT® WINDOWS® (Redmond, Wash., USA).

A representative on-screen timer 340 comprises trough 344, timing bar 346, and ten subdivisions 342, each subdivision 342 corresponding to one tenth of the time allotted within the on-screen timer 340. Set against the light grey rectangle defining the maximum perimeter of exemplary on-screen timer 340, trough 344 comprises a dark grey rectangular region centered with respect to representative on-screen timer 340. Within trough 344, timing bar 346 comprises a green rectangle aligned with the leftmost portion of trough 344.

At the start of the allotted time cycle, timing bar 346 is a green rectangle that completely fills trough 344. As the cycle begins, timing bar 346 decreases in length along trough 344 while maintaining alignment with the leftmost portion of trough 344. When an allotted time remains (as may be set in 236), timing bar 346 changes color from green to yellow. When one minute of the allotted time remains, timing bar 346 changes color from yellow to red. When all of the allotted time has passed, timing bar 346 disappears and the dark grey trough 344 remains.

In the event that user input 110 is consistent with an audible warning, system 100 may be configured to produce a sound in response to passage of time. For example, system 100 may be configured to produce a “ding” in response to the allotted time remaining (as may be set in 236), a second “ding” in response to one minute remaining of the allotted time, and a “buzz” in response to passage of all of the allotted time. As another example, system 100 may be configured to produce a “beep” after the passage of each minute, two “beeps” when one minute remains, and three “beeps” when time has expired.

Exemplary on-screen timer 340 may be responsive to user input during operation. Exemplary on-screen timer 340 may be suitably configured to generate an option menu in response to a mouse click in the vicinity of on-screen timer 340. For example, such options menu may provide for display or a digital clock suitably configured to display the time that has passed and/or the time that is remaining. As another example, such options menu may provide for pausing, cancellation, modification to the allotted time, modification of display properties, and/or the like.

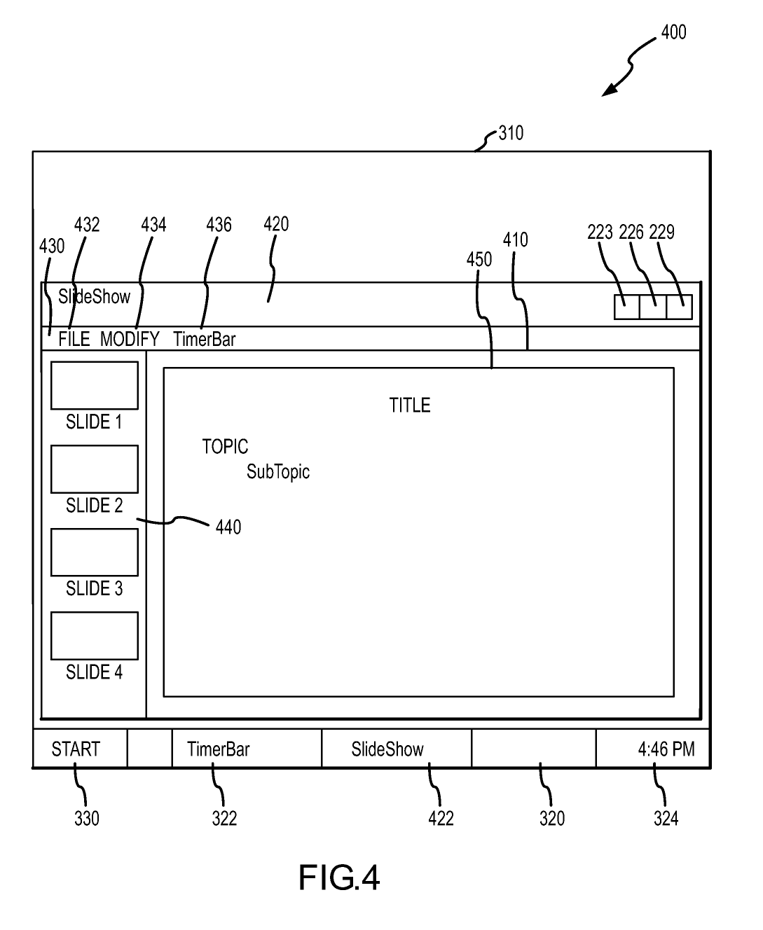

As generally depicted in FIG. 4, a representative embodiment of the present invention includes a screen shot of an exemplary embodiment 340 for an on-screen timer 170 integrated within slideshow program 410. Slideshow program 410 may operate within GUI 400. Within GUI 400, slideshow program 410 may comprises various fields such as window properties field 420, command field 430, slideshow preview field 440, slide editor field 450, and/or the like. Exemplary on-screen timer 340 may be accessed via command field 430.

GUI 400 may comprise a display screen running a GUI operating system. For example, GUI 400 may comprise a desktop screen of the GUI operating system sold under the name MICROSOFT® WINDOWS® (Redmond, Wash., USA). The properties of GUI 400 may vary according to the parameters of GUI 400 and/or user preferences.

Slideshow program 410 may comprise a software program configured to aid a user in generating presentation materials. For example, slideshow program 410 may comprise the presentation software sold under the name MICROSOFT® POWERPOINT® (Redmond, Wash., USA).

Window properties field 420 may comprise a field within slideshow program 410 displaying information relating to operation of system 100. Window properties field 420 may comprise text relating to the filename and/or path of system 100. Window properties field 420 may comprise subfields such as minimize field 223, restore/maximize field 226, and/or close field 229. Window properties field 220 may be suitably configured in accordance with a uniform interface scheme within an operating system.

Command field 430 may comprise a plurality of menus accessed through activation of a menu icon. For example, command field 430 may comprise file menu icon 432 suitably configured to access commands such as save, print, new file, and/or the like. As another example, command field 430 may comprise modify menu icon 434 suitably configured to access commands such as delete, cut, paste, and/or the like. In the present embodiment, command field 430 also comprises TimerBar menu icon 436 suitably configured to access system 100 and on-screen timer 107 via slideshow program 410.

TimerBar menu icon 436 may access system 100 in various ways. For example, actuation of TimerBar menu icon 436 may simply trigger launch of GUI 200 and receive user input 110 accordingly. As another example, actuation of TimerBar menu icon 436 may comprise a plurality of commands such as set total time, settings, define trigger event, and/or the like with which a user may define the properties of on-screen timer 170.

In an integrated configuration, system 100 may be configured to display on-screen timer 170 in response to activation of the full-screen mode of slideshow program 410. Many presentation programs, including that sold under the name MICROSOFT® POWERPOINT® (Redmond, Wash., USA) feature full-screen presentation modes in which a presentation file appears slide-by-slide in a full-screen format. In the context of meetings and/or presentations, many presenters make use of this full-screen mode, frequently in conjunction with a projector, to display the contents of a slideshow file to an audience. Accordingly, when on-screen timer 170 is triggered in response to activation of full-screen mode, all parties may receive information relating to the passage of time in conjunction with the presentation. System 100 may be suitably configured within the display hierarchy of an operating system to provide an on-screen timer 170 in addition to any other graphical displays.

Slideshow preview field 440 may comprise a distinct field within slideshow program 410 with which a user may view multiple slides within a presentation. Such a feature is standard within many presentation programs, including that sold under the name MICROSOFT® POWERPOINT® (Redmond, Wash., USA).

Slide editor field 450 may comprise a distinct field within slideshow program 410 with which a user may manipulate the properties of a slide. Such a feature is standard within many presentation programs, including that sold under the name MICROSOFT® POWERPOINT® (Redmond, Wash., USA).

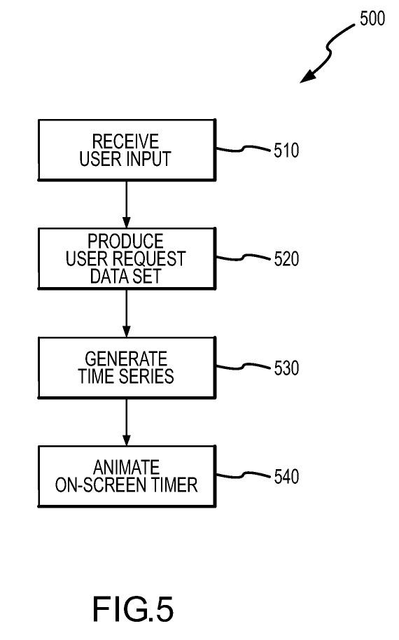

As generally depicted in FIG. 5, a representative embodiment of the present invention includes a flowchart 500 for generating on-screen timer 170 via system 100. A suitably configured hardware and/or software system 100 may be configured to receive user input 110 (510). System 100 may also be suitably configured to produce user request data set 130 (520) in response to receipt of user input 110 (510). System 100 may be further configured to generate time series 150 (530) in response to user request data set 130. System 100 may also be suitably configured to animate on-screen timer 170 (540) in response to at least one of user request data set 130 and time series 170.

User input 110 may be received (510) in any suitable manner and in various ways. For example, user input 110 may be entered into a computer keyboard within an appropriate field of a GUI. As another example, user input 110 may be entered via a computer mouse by selecting from a menu of options within a GUI. As yet a further example, user input 110 may be entered via a touchscreen responsive to user activity.

For user input 110 comprising a signal, receipt (510) of such input 110 may comprise preliminary subroutines such as normalization of the signal, offsetting the signal, and/or the like. In addition, an operating system may be placed in communication with peripheral devices with which a user may provide user input 110. Accordingly, such operating system may perform preliminary subroutines with respect to the signal received by the peripheral prior to receipt of user input 110 (510) within system 100.

User request data set 130 may be produced (520) in any suitable manner and in various embodiments. For example, system 100 may comprise a subroutine such as an input module 120 configured to format, process, and/or otherwise manipulate user input 110 to provide user request data set 130 for further processing within system 100.

Time series 150 may be generated (530) in any suitable manner and in various ways. For example, system 100 may comprise a subroutine, such as a run module 140 configured to format, process, and/or otherwise manipulate user input 110 and/or a user request data set 130 to provide a relationship between the desired on-screen timer and the available graphics options for further processing within system 100.

On-screen timer 170 may be animated (540) in any suitable manner and in various ways. For example, system 100 may comprise a subroutine, such as a display module 160 configured to selectively produce a graphic relating an allotted time to a specified graphic.

The descriptions contained herein are of exemplary embodiments of the invention and the inventor's conception of the best mode and are not intended to limit the scope, applicability or configuration of the invention in any way. Rather, the following description is intended to provide convenient illustrations for implementing various embodiments of the invention. As will become apparent, changes may be made in the function and/or arrangement of any of the elements described in the disclosed exemplary embodiments without departing from the spirit and scope of the invention.

The present invention may be described herein in terms of functional block components, optional selections and various processing steps. It should be appreciated that such functional blocks may be realized by any number of hardware and/or software components configured to perform the specified functions. For example, the present invention may employ various integrated circuit components, e.g., memory elements, processing elements, logic elements, matchable data structures, and the like, which may carry out a variety of functions under the control of one or more microprocessors or other control devices.

Similarly, the software elements of the present invention may be implemented with any programming or scripting language such as, for example, C, C++, Java, COBOL, assembler, PERL, eXtensible Markup Language (XML), a development environment such as that sold under the name NATIONAL INSTRUMENTS® LABWINDOWS™/CVI, etc., or any programming or scripting language now known or hereafter derived in the art, with the various algorithms being implemented with any combination of data structures, objects, processes, routines or other programming elements. Further, it should be noted that the present invention may employ any number of conventional techniques for data transmission, signaling, data processing, network control, and the like. Still further, the invention could be used to detect or prevent security issues with a client-side scripting language, such as JavaScript, VBScript or the like. For a basic introduction to cryptography, please review the text written by Bruce Schneider entitled “Applied Cryptography: Protocols, Algorithms, And Source Code In C,” published by John Wiley & Sons (second edition, 1996).

It should be appreciated that the particular implementations shown and described herein are illustrative of the invention and its best mode and are not intended to otherwise limit the scope of the present invention in any way. Indeed, for the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

It will be appreciated, that many applications of the present invention could be formulated. One skilled in the art will appreciate that the network may include any system for exchanging data, such as, for example, the Internet, an intranet, an extranet, WAN, LAN, PAN, satellite communications, and/or the like. It is noted that the network may be implemented as other types of networks, such as an interactive television (ITV) network. The users may interact with the system via any input device such as a keyboard, mouse, kiosk, personal digital assistant, handheld computer (e.g., PALM PILOT®), cellular phone and/or the like. Similarly, the invention could be used in conjunction with any type of personal computer, network computer, workstation, minicomputer, mainframe, or the like running any operating system such as any version of Windows, Windows XP, Windows Whistler, Windows ME, Windows NT, Windows2000, Windows 98, Windows 95, MacOS, OS/2, BeOS, Linux, UNIX, or any operating system now known or hereafter derived by those skilled in the art. Moreover, the invention may be readily implemented with TCP/IP communications protocols, IPX, Appletalk, IP-6, NetBIOS, OSI or any number of existing or future protocols. Additionally, the system contemplates the use, sale and/or distribution of any goods, services or information having similar functionality described herein.

Computing units may be connected with each other via a data communication network. The network may be a public network and assumed to be insecure and open to eavesdroppers. In one exemplary implementation, the network may be embodied as the Internet. In this context, the computers may or may not be connected to the Internet at all times. Specific information related to data traffic protocols, standards, and application software utilized in connection with the Internet may be obtained, for example, from DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997). LOSHIN, TCP/IP CLEARLY EXPLAINED (1997). A variety of conventional communications media and protocols may be used for data links, such as, for example, a connection to an Internet Service Provider (ISP) over the local loop, as is typically used in connection with standard modem communication, cable modem, Dish networks, ISDN, Digital Subscriber Line (DSL), or various wireless communication methods. Various systems and sub-systems might also reside within a local area network (LAN) which interfaces to a network via a leased line (T1, T3, etc.). Such communication methods are well known in the art, and are covered in a variety of standard texts. See, e.g., GILBERT HELD, UNDERSTANDING DATA COMMUNICATIONS (1996).

The present invention may be embodied as a method, a system, a device, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

Data communication may be accomplished through any suitable communication means, such as, for example, a telephone network, intranet, Internet, point of interaction device (point of sale device, personal digital assistant, cellular phone, kiosk, etc.), online communications, off-line communications, wireless communications, and/or the like. It will also be appreciated that, for security reasons, any databases, systems, or components of the present invention may consist of any combination of databases or components at a single location or at multiple locations, wherein each database or system includes any of various suitable security features, such as firewalls, access codes, encryption, de-encryption, compression, decompression, and/or the like.

In the foregoing specification, the invention has been described with reference to specific exemplary embodiments; however, it will be appreciated that various modifications and changes may be made without departing from the scope of the present invention as set forth in the claims below. The specification and figures are to be regarded in an illustrative manner, rather than a restrictive one and all such modifications are intended to be included within the scope of the present invention. Accordingly, the scope of the invention should be determined by the claims appended hereto and their legal equivalents rather than by merely the examples described above.

For example, the steps recited in any method or process claims may be executed in any order and are not limited to the specific order presented in the claims. Additionally, the components and/or elements recited in any apparatus claims may be assembled or otherwise operationally configured in a variety of permutations to produce substantially the same result as the present invention and are accordingly not limited to the specific configuration recited in the claims.

Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of any or all the claims.

As used herein, the terms “including”, “comprising”, “having”, or any contextual variant thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

We claim:

1. A computer-readable medium containing instructions for causing a computer system to display a timer, said timer comprising:
an input module responsive to a user input, wherein the input module generates a user request data set in response to the user input;
a run module responsive to the user request data set, wherein the run module generates a time series in accordance with the user request data set; and
a display module responsive to the time series, wherein the display module displays an on-screen timer in accordance with the time series and the user request data set.

2. The computer-readable medium according to claim 1, wherein the input module is responsive to a signal from at least one of a computer keyboard, a computer mouse, and a touchscreen.

3. The computer-readable medium according to claim 1, wherein the user request data set comprises machine-readable code formatted for processing within at least one of the run module and the display module.

4. The computer-readable medium according to claim 1, wherein the run module comprises a graphics library and wherein the run module generates a time series relating portions of the graphics library to the user request data set.

5. The computer-readable medium according to claim 1, wherein the display module selectively displays the time series in response to a specified trigger event.

6. The computer-readable medium according to claim 1, wherein the timer comprises a graphical display simulating at least one of a timing bar, a digital clock, an analog clock, an hourglass, a solar cycle, a lunar cycle, and a pastoral setting cycling through seasons.

7. The computer-readable medium according to claim 1, wherein the timer is integrated within a slideshow software program and selectively activated in response to a specified trigger event.

8. A computer-implemented method for providing a timer, said method comprising the steps of:
receiving a user input;
producing a user request data set in response to the user input;
generating a time series in response to the user request data set; and
displaying an on-screen timer in accordance with the time series and the user request data set.

9. The computer-implemented method according to claim 8, wherein the user input is received within an input module, and wherein the input module is responsive to a signal from at least one of a computer keyboard, a computer mouse, and a touchscreen.

10. The computer-implemented method according to claim 8, wherein the user request data set comprises machine-readable code formatted for processing within a run module and a display module.

11. The computer-implemented method according to claim 8, wherein the time series is generated via a run module, and wherein the run module comprises a graphics library.

12. The computer-implemented method according to claim 8, further comprising the step of providing a display module, wherein the display module selectively displays the on-screen timer in accordance with the user request data set and the time series.

13. The computer-implemented method according to claim 8, wherein the timer comprises at graphical display simulating at least one of a timing bar, a digital clock, an analog clock, an hourglass, a solar cycle, a lunar cycle, and a pastoral setting cycling through seasons.

14. The computer-implemented method according to claim 8, wherein the timer is integrated within a slideshow software program and selectively activated in response to a specified trigger event.

15. A computer-implemented method for integrating a timer within a slideshow software program, said method comprising the steps of:
receiving a user input via an input module;
generating a user request data set via the input module;
generating a time series in accordance with the user request data set via a run module;
displaying an on-screen timer in accordance with the user request data set and the time series via a display module; and
activating the display module in response to a specified trigger event.

16. The computer-implemented method according to claim 15, wherein the input module is responsive to a signal from at least one of a computer keyboard, a computer mouse, and a touchscreen.

17. The computer-implemented method according to claim 15, wherein the user request data set comprises machine-readable code formatted for processing within at least one of the run module and the display module.

18. The computer-implemented method according to claim 15, wherein the run module comprises a graphics library and wherein the run module generates a time series relating portions of the graphics library to the user request data set.

19. The computer-implemented method according to claim 15, wherein the display module selectively displays the on-screen timer in accordance with the user request data set and the time series.

20. The computer-implemented method according to claim 15, wherein the timer comprises at graphical display simulating at least one of a timing bar, a digital clock, an analog clock, an hourglass, a solar cycle, a lunar cycle, and a pastoral setting cycling through seasons.
